(19) United States
(12) Patent Application Publication
(10) Pub. No.: US 2018/0223112 A1
(43) Pub. Date: Aug. 9, 2018

(54) Chemical Formulation And Method Of Fouling Control Using Same

(71) Applicant: Buckman Laboratories International, Inc., Memphis, TN (US)

(72) Inventor: Percy Jaquess, Cordova, TN (US)

(73) Assignee: Buckman Laboratories International, Inc., Memphis, TN (US)

(21) Appl. No.: 15/888,107

(22) Filed: Feb. 5, 2018

Related U.S. Application Data
(60) Provisional application No. 62/456,134, filed on Feb. 8, 2017.

(51) Int. Cl. C09D 5/16; B01D 3/00; C09D 7/63

(52) U.S. Cl. CPC C09D 5/1625; C09D 7/63; B01D 3/001

(57) ABSTRACT

A chemical formulation which controls fouling in process units, such as alcohol distillation columns, has at least two non-ionic surfactants, at least one anti-foam agent, at least one alcohol, optionally at least one preservative, and water. The chemical formulation is animal food grade. A method of using the chemical formulation to control fouling in a process unit during ongoing continuous operation also is provided.

This application claims the benefit under 35 U.S.C. § 119(e) of prior U.S. Provisional Patent Application No. 62/456,134, filed Feb. 8, 2017, which is incorporated in its entirety by reference herein.

### BACKGROUND OF THE INVENTION

The present invention relates to a chemical formulation and a method of using the chemical formulation to control fouling in process units, such as alcohol distillation columns.

A typical corn to ethanol plant includes one or more beer wells, which are used to store fermented mash liquor from a fermentation vessel(s). The beer well(s) can provide a continuous feed supply of the fermented mash liquor to a distillation column, such as shown in U.S. Pat. No. 8,951,960, which is incorporated in its entirety by reference herein. The distillation column generates ethanol-rich vapor which is recovered in condensed overhead product. Bottom product (stillage) from this process, which contains non-fermentable solids and water, can be pumped out from the bottom of the column, and further processed for use in animal feed or other purposes.

A typical distillation column for ethanol recovery in an ethanol plant is separated into stages by the presence of trays mounted inside the column at spaced locations along its column height. These trays allow for vapor-liquid contact and equilibrium to occur. A common tray type is a sieve tray, which is a sheet of metal with perforations or holes punched or drilled into it. The sieve tray provides a contact surface for vapor/liquid mixing and separation, and allows vapor to flow upward and liquid to flow downward through the distillation column. At an industrial scale, a corn to ethanol distillation column typically is designed to be operated on a continuous basis. The trays, internal walls and other parts in the ethanol distillation column are subject to heavy accumulation of hardened deposits or scale, also referred to as fouling. This fouling can accumulate relatively rapidly, e.g., within weeks of operation. As a result, the distillation trays become plugged in the perforated areas with hardened deposits, i.e., fouled. Fouling can build back-pressure in the distillation column, such as within one to two weeks of operation, requiring process shutdown for cleaning. Distillation columns so fouled can require an entire work day or more to be cleaned before operation can be restored.

Harsh acids and bases have been used to remove the deposits from the trays and other internal surfaces of the distillation column. The harsh cleaning agents, however, need to be thoroughly removed from the column before process operations can be restored. The stillage liquor that collects in the distillation column, for instance, is commonly used downstream in the process to produce distillers grains (e.g., wet distillers grains plus solubles (WDGS), dried distillers grains with solubles (DDGS)) used in animal feed. Contact between mash liquid and harsh non-animal food grade cleaning chemicals thus needs to be avoided. As another cleaning method, manual cleaning of the trays, such as using extensive scraping and chiseling, has been used to remove hardened deposits from the surfaces of the trays and other internal surfaces of the distillation column. Oxidant amines and detergents have sometimes been used to soften the deposits before the scraping and chiseling is begun. Use of the harsh cleaning chemicals or manual scraping for cleaning requires process shutdown. This results in a significant process disruption and lost production, and added maintenance costs that are recurring.

It would be desirable to prevent the initial formation and accumulation of hardened scale deposits on trays or other internal surfaces of alcohol distillation columns as a preventive measure instead of relying on remedial measures, to reduce the need for production stoppage and the expenditure of resources for scale removal maintenance.

### SUMMARY OF THE PRESENT INVENTION

A feature of the present invention is to provide a chemical formulation which can be used during an ongoing distillation process to control, e.g., prevent or at least reduce, the formation and accumulation of hardened scale deposits on trays, walls, or other internal surfaces of an alcohol distillation column or other process unit.

Another feature of the present invention is to provide a chemical formulation which can control scale deposit development in distillation columns, wherein the chemical formulation is acceptable as an animal food additive and compatible with animal feed materials derived from products of the distillation column, and thus can be used during ongoing distillation processes.

A further feature of the present invention is to provide a chemical formulation which can control development of hardened scale deposits on surfaces in an alcohol distillation column as part of a continuous or extended process operation, so that there is less production downtime needed for cleaning.

An additional feature of the present invention is to provide a chemical formulation which can control deposit formation on surfaces in an alcohol distillation column which reduces or eliminates the need to use labor-intensive manual scraping or harsh or non-animal food grade cleaning chemicals for scale deposit removal.

Another feature of the present invention is to provide a method to control fouling in a distillation column using the indicated chemical formulation.

A further feature of the present invention is to provide the indicated method to control fouling in a distillation column as a clean-in-place (CIP) method that occurs in-process without the need to shut down the operation of the distillation column.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a chemical formulation comprising a) at least two non-ionic surfactants, b) at least one anti-foam agent, c) at least one alcohol, d) optionally at least one preservative, and e) water, wherein a) through d) are different from each other, and wherein the chemical formulation is animal food grade.

The present invention further relates to a method to control fouling in a distillation column comprising conducting distillation in the distillation column in the presence of the indicated chemical formulation.

As used herein, “control”, or variants such as “controls” or “controlling”, refers to at least a reduction in scale or deposit formation (i.e., fouling) on a surface, such as a sieve tray surface in a distillation column. The reduction may be based on a comparison to the fouling that occurs on the surface in the absence of treatment with the chemical formulation of the present invention, such as with no treatment. The reduction can be complete prevention or partial reduction in scale or deposit formation on the surface. With respect to a sieve tray surface, the extent of scale or deposit formation may be assessed, for example, based on the percentage of the total surface area (holes and lands) that is completely covered (“blinded”) by deposit material, or by pressure drop monitoring on the tray(s) during column operation, or by other criteria.

It is to be understood that both the foregoing general description and the following detailed description are exemplary and explanatory only and intended to provide a further explanation of the present invention, as claimed.

### BRIEF DESCRIPTION OF DRAWINGS

FIG. 1 is a process flow diagram of a method of introduction of a chemical formulation as an anti-fouling composition into a distillation column that forms part of an ethanol production plant according to an example of the present application.

FIG. 2 is a sectional plan view of a sieve tray in a distillation column which is treated with the anti-fouling composition according to an example of the present application.

FIG. 3 is a sectional side view of two adjacent sieve trays in a distillation column which are treated with an anti-fouling composition according to an example of the present application.

FIG. 4 is a photograph which shows the surface of a treated test slide after treatment with an anti-fouling composition according to an example of the present invention (“C”) and those of test slides treated with comparison products (“A”, “B”, “D”, “E”) and a control (no additive).

### DETAILED DESCRIPTION OF THE PRESENT INVENTION

The present invention relates, in part, to a chemical formulation which can be used to control fouling within a process unit, such as a distillation column (e.g., an alcohol distillation column). The chemical formulation of the present invention is an animal food grade composition which comprises at least two non-ionic surfactants, at least one anti-foam agent, at least one alcohol, optionally at least one preservative, and water, wherein the non-ionic surfactants, anti-foam agent(s), alcohol(s), and the preservative(s) are different from each other.

The chemical formulation of the present invention can be used to treat surfaces and materials inside a process unit during an ongoing process operation to provide fouling control, such as during an ongoing alcohol distillation process. Further, deposit control can be provided in continuous processes that only allow animal feed additives which are acceptable for food. The chemical formulation of the present invention can be used in an in-process treatment, as the material is acceptable as an animal food additive and compatible with animal feed materials, such as, e.g., those derived from bottom products (stillage) of an alcohol distillation column. The chemical formulation thus can be used as part of a clean-in-place (CIP) method, which provides in-process control of scale deposit formation on internal surfaces, such as trays, vessel walls, or other internal parts, of an alcohol distillation column. Treatment of a process unit during an ongoing process with the chemical formulation of the present invention can act as a preventive measure to prevent or disrupt initial formation of scale deposits on internal surfaces before hardened deposit accumulation can occur. This is preferable to a remedial measure that is applied only after hardened scale deposits have already formed on process unit surfaces. This performance advantage of the present invention can reduce or eliminate the need for production stoppage for tray cleaning maintenance, or at least extend the duration of continuous operation before such cleaning may become necessary, on an alcohol distillation column or other treated process unit. The need for manual scraping, or harsh or non-animal food grade chemicals, to remove scale deposits from internal surfaces of a distillation column can be reduced or completely avoided with the present invention.

The chemical formulation of the present invention can provide fouling control against different kinds of scale and deposit formation, which can otherwise develop in an untreated process unit, such as in an untreated alcohol distillation column. Inorganic, organic, or both types of deposits can form on the trays and other internal surfaces of an ethanol distillation column during the distillation process from components introduced with fermented mash liquor (e.g., fermented mash supplied from a beerwell or “beer”), if not controlled. The deposits can comprise, for example, proteins, glycoproteins, sugar, sugar residuals, and/or minerals or any combination thereof. The minerals can be ionic minerals, such as calcium deposits, phosphates (e.g., calcium phosphates), other inorganic calcium salts, organic calcium salts (e.g., calcium oxalates), or other minerals, or any combination thereof. Polymer deposits can form on surfaces inside a distillation column, if left uncontrolled. Conditions inside the ethanol distillation column, absent anti-fouling control, can be conducive for in situ polymer deposit formation, e.g., polymeric resin deposits, on internal surfaces of the column. Though not desiring to be bound to any theory, this polymer formation may be attributable, at least in part, to the presence of polymerizable fermented mash components or derivatives thereof, such as, e.g., furfurals, furan, tetrahydrofurals, and the like, when subjected to elevated temperatures in the distillation column. The chemical formulation of the present invention can interfere with thermosetting and thermal plasticization (e.g., thermosetting and thermal plasticization of furfurals and tetrahydrofuran derivative polymerization).

As shown, for example, in the Examples disclosed herein, the chemical formulation of the present invention provides surprisingly superior control (e.g., up to 100% prevention) of scale deposit coverage, for instance, achieving complete prevention, almost complete prevention, or control of the deposits, such that shutdown of the process (e.g., distillation) is not necessary. The present invention can provide prevention or control of the surface area of a contact surface that is contacted with beer well (fermented) mash under distillation conditions, compared to treatments that use comparison compositions that contained only one or subgroups of the components of the chemical formulation, or used compositions that contained other types of treatment agents.

The chemical formulation of the present invention can control fouling to permit operation of a distillation column, such as an ethanol distillation column of any scale including industrial scale, to be maintained for long periods of continuous operation, such as for at least 2 weeks or more, or for at least 4 weeks or more, or for at least 8 weeks or more, or for at least 16 weeks or more, or for at least 24 weeks or more, or for at least one 52 weeks or more, or for at least 75 weeks or more, or for 4 weeks to 75 weeks, or for 8 weeks to 52 weeks, or for other periods of continuous operation. The chemical formulation of the present invention can have other performance advantages, such as those that are discussed in the further description below.

The chemical formulation of the present invention is animal food grade, and each of the individual ingredients of the chemical formulation can meet this criterion. As indicated, the bottom products (stillage) of an ethanol distillation column is commonly used in an ethanol production plant in downstream processing to produce distillers grains or other products used in animal feed. An in-process additive needs to be compatible with regulatory requirements applicable to such products. As a preferred option, each of the non-ionic surfactants, anti-foam agent, alcohol, preservative, and water used in the chemical formulation of the present invention is specifically allowed for use under regulations administered by the FDA (e.g., food grade), or is Generally Recognized As Safe (GRAS) status, or both.

As used herein, a “non-ionic surfactant” is an organic compound that is amphiphilic and has no charge group at either terminal end group thereof, wherein the organic compound can lower the surface tension of a liquid, the interfacial tension between two liquids, or that between a liquid and a solid. The non-ionic surfactant can be at least one polysorbate. The non-ionic surfactant can be at least one alkoxylated castor oil. The non-ionic surfactant can be an ethoxylated sorbitan ester (polysorbate), an ethoxylated castor oil, a glyceride ethoxylate, an alcohol ethoxylate, an alkylphenol ethoxylate, a phenol ethoxylate, an amide ethoxylate, a fatty acid ethoxylate, a fatty amine ethoxylate, a fatty amide ethoxylate, a fatty mono or di-ethanolamide, an alkyl glycoside, a poloxamer, an alkali metal arylsulfonate, an ethoxylated fatty amide, and/or other non-ionic surfactants, which can be used in a single kind or any combination thereof. The total amount of the at least two different non-ionic surfactants included in the chemical formulation of the present invention can be in a concentration of from about 10 wt % to about 20% wt %, or from about 12 wt % to about 18 wt %, or from about 14 wt % to about 16 wt %, or other concentrations, based on total weight of the chemical formulation.

As an option, at least one of the two different non-ionic surfactants used in the chemical formulation of the present invention can be an ethoxylated sorbitan ester. Ethoxylated sorbitan esters are also known as polysorbates, and these terms are used interchangeably herein. One kind of polysorbate, or two, three or more different kinds of polysorbates in combination, can be used in the chemical formulation of the present invention. The polysorbate may be polyoxyethylene sorbitan monolaurate, polyoxyethylene sorbitan monopalmitate, polyoxyethylene sorbitan monostearate, polyoxyethylene sorbitan monooleate, or other suitable or mono-, di- or triesters of sorbitan based on fatty acids having 12-22 carbon atoms, of a single kind or any combination thereof. The polysorbates can be commercially obtained as TWEEN or polysorbate series surfactant, such as polysorbate (80) (e.g., (TWEEN 80), polysorbate (20) (e.g., TWEEN 20), polysorbate (40) (e.g., TWEEN 40), or polysorbate 60 (e.g., TWEEN 60). TWEEN 80 is (polyoxyethylene (20) sorbitan monooleate. Other commercial sources of the polysorbates which can be used in a chemical formulation of the present invention include, for example, Lumisorb Polysorbates from Lambent Technologies Corporation (Gurnee, Ill. USA). The total amount of the polysorbate, if used as one the at least two different non-ionic surfactants included in the chemical formulation of the present invention, can be in a concentration of from about 5 wt % to about 15% wt %, or from about 7 wt % to about 13 wt %, or from about 9 wt % to about 11 wt %, or other concentrations, based on total weight of the chemical formulation.

As an option, at least one of the two different non-ionic surfactants used in the chemical formulation of the present invention can be an alkoxylated castor oil. The alkoxylated castor oil can be ethoxylated castor oil. An ethoxylated castor oil can be prepared by ethoxylating castor oil, either naturally occurring or hydrogenated, under oxyalkylation conditions. As generally known, ethoxylation of the castor oil can be achieved by condensing a prescribed amount of ethylene oxide with the castor oil in the presence of a suitable catalyst. The ethoxylated castor oil can have from 20 to 90 moles of ethylene oxide (EO) per mole of castor Oil, or from 30 to 80 moles of EO per mole of castor oil, or from 40 to 60 moles of EO per mole of castor oil, or other EO content. The ethoxylated castor oil can have a fatty acid end carbon number, such as from 10 to 20, 12 to 18, or 15 to 16, or other values. A commercial source of the ethoxylated castor oil can be T-Det C-40®, available from Harcros Chemicals Inc. The total amount of the ethoxylating castor oil, if used as one the at least two different non-ionic surfactants included in the chemical formulation of the present invention, can be in a concentration of from about 2 wt % to about 10% wt %, or from about 3 wt % to about 9 wt %, or from about 4 wt % to about 8 wt %, or other concentrations, based on total weight of the chemical formulation.

The nonionic surfactants, such as the ethoxylated sorbitan ester, alkoxylated castor oil, or other nonionic surfactants, can have a hydrophile-lipophile balance value (HLB value) of from about 2 to about 39, or an HLB value of from about 7 to about 25, or an HLB value of from about 10 to about 20, or an HLB value of from about 12 to about 18, or an HLB value of from about 14 to about 16, or an HLB value of about 15, or other values. When combinations of different surfactants are used, the weighted average of the individual surfactant components can be used to calculate the HLB of the combination. The HLB value can be calculated in a conventional manner. For example, the HLB value of a surface active agent can be calculated by dividing the molecular weight percent of the hydrophilic portion of the surface active agent by five. For example, a surfactant/wetting agent containing 20 mole % hydrophilic portion (total) would have an HLB value calculated to be 4 (i.e., 20/5=4). HLB values that exceed 20 are relative or comparative values. Additives with a low HLB are more lipid loving while those with a high HLB are more hydrophilic.

The anti-foam agent can be at least one polyglycol. The one or more polyglycols can be polyethylene glycols (PEGs), methoxypolyethylene glycols (MPEGs), polypropylene glycols (PPGs), polybutylene glycols (PBGs), polyglycol copolymers, or other polyalkylene glycols, which can be used in a single kind or any combination thereof. PEGs may be used that have an average molecular weight of from about 500 to about 8000, or from about 750 to about 7500, or from about 1000 to about 5000, or from about 2000 to about 4000, or other values. PEGs are commercially available, such as CARBOWAX products from Dow Chemical Company. The total amount of the anti-foam agent included in the chemical formulation of the present invention can be in a concentration of from about 1 wt % to about 10% wt %, from about 2 wt % to about 10% wt %, or from about 3 wt % to about 9 wt %, or from about 4 wt % to about 8 wt %, or other concentrations, based on total weight of the chemical formulation.

The alcohol component of the chemical formulation can be at least one polyhydric alcohol. As an option, any polyhydric alcohol containing at least two, or at least three, hydroxyl groups can be used. Examples of the polyhydric alcohol include polyhydric C₃₋₁₅ alcohols having three to six hydroxyl groups such as glycerol (a.k.a. glycerin or propane-1,2,3-triol), digycerin, polyglycerin, sorbitol, glucose, trimethylolpropane, trimethylolethane, 1,2,4-butanetriol, 1,2,6-hexanetriol, 1,1,1-trimethylolhexane, pentaerythritol, erythrose, tetramethylol, cyclohexatriol, or other polyhydric alcohols, which can be used in a single kind or any combination thereof. The total amount of the alcohol included in the chemical formulation of the present invention can be in a concentration of from about 25 wt % to about 50% wt %, or from about 30 wt % to about 50 wt %, or from about 35 wt % to about 45 wt %, or other concentrations, based on total weight of the chemical formulation.

The preservative component of the chemical formulation is optional, and if present, can be one or more chemical preservatives (e.g., benzoates, sorbates, citrates, and salts thereof), chelating agents (e.g., sodium hexametaphosphate, ethylenediaminetetraacetic acid (EDTA)), free fatty acids, esters and derivatives thereof, peptides, lauric arginate, cultured dextrose, neem oil, or other chemical preservatives, which can be used in a single kind or any combination thereof. Additional preservatives, may include, but are not limited to, antimicrobials such as flavonoids, lactic acid, sorbic acid, acetic acid, and citric acid, or any combination thereof. In a preferred example, a benzoate, a sorbate, or both are used as the preservative. Examples include sodium benzoate, potassium sorbate, sodium sorbate, or any combination thereof. The total amount of the preservative included in the chemical formulation of the present invention can be in a concentration of from about 0.25 wt % to about 5% wt %, or from about 0.25 wt % to about 3 wt %, or from about 0.5 wt % to about 2.5 wt %, or other concentrations, based on total weight of the chemical formulation.

The chemical formulation of the present invention also contains water. The water can be deionized water, distilled water, filtered water, tap water, or any combination thereof. The total amount of the water included in the chemical formulation of the present invention, from all sources, can be in a concentration of from about 1 wt % to about 40% wt %, or from about 10 wt % to about 40 wt %, or from about 15 wt % to about 35 wt %, or other concentrations, based on total weight of the chemical formulation.

The chemical formulation of the present invention can comprise from about 10 wt % to about 20 wt % of the at least two non-ionic surfactants, from about 1 wt % to about 10 wt % of the at least one anti-foam agent, from about 25 wt % to about 50 wt % of the at least one alcohol, from about 0.25 wt % to about 5 wt % of the at least one preservative, and from about 1 wt % to about 40 wt % of the water, all based on total weight of the chemical formulation. As an option, the chemical formulation can comprise from about 12 wt % to about 18 wt % of the at least two non-ionic surfactants, from about 2 wt % to about 10 wt % of the at least one anti-foam agent, from about 30 wt % to about 50 wt % of the at least one alcohol, from about 0.25 wt % to about 3 wt % of the at least one preservative, and from about 10 wt % to about 40 wt % of the water, all based on total weight of the chemical formulation. As a specific option, the chemical formulation can comprise from about 5 wt % to about 15 wt % of at least one polysorbate, from about 2 wt % to about 10 wt % of at least one ethoxylated castor oil, from about 2 wt % to about 10 wt % of at least one polyglycol, from about 30 wt % to about 50 wt % of at least one glycerol, from about 0.25 wt % to about 3 wt % of at least one preservative, and from about 10 wt % to about 40 wt % water, based on total weight of the chemical formulation. As a more specific option, the chemical formulation can comprise from about 7 wt % to about 13 wt % of at least one polysorbate, from about 3 wt % to about 9 wt % of at least one ethoxylated castor oil, from about 3 wt % to about 9 wt % of at least one polyglycol, from about 35 wt % to about 45 wt % of at least one glycerol, from about 0.5 wt % to about 2.5 wt % of at least one preservative, and from about 15 wt % to about 35 wt % water, based on total weight of the chemical formulation.

The components of the chemical formulation can be combined in any order and blended with agitation/stirring equipment to provide a mixture, which can be a stable homogenous mixture.

The chemical formulation can be in a flowable state and/or in liquid form, such as at room temperature and pressure conditions, which is pumpable, or sprayable, or both. As explained in more detail herein, the chemical formulation can be pumped (or otherwise introduced) into the line going from beer well to the distillation column, and/or can be pumped (or otherwise introduced) at other access points to the distillation column.

Additional ingredients may be included in the chemical formulation as optional ingredients provided that the additional ingredients are animal food grade and do not interfere with the anti-fouling activity of the chemical formulation. In an option, the chemical formulation contains no more than 5 wt % (0-5 wt %), or no more than 4 wt % (0-4 wt %), or no more than 3 wt % (0-3 wt %), or no more than 2 wt % (0-2 wt %), or no more than 1 wt % (0-1 wt %), or no more than 0.1 wt % (0-0.1 wt %), or no more than 100 ppm (0-100 ppm), of any other component(s), individually or as a total, that are not the non-ionic surfactants, anti-foam agent, alcohol, preservative, or water used in the chemical formulation, based on total weight of the chemical formulation. As an option, these concentration limitations can apply to silanes, silicon, silicone, acids, bases, cationic surfactants, and/or anionic surfactants, or other optional additives. As a more specific option, the chemical formulation is silane-free, and/or silicon-free, and/or silicone-free. As an option, the chemical formulation is acid-free, and/or base-free, and/or cationic-free surfactant, and/or anionic-free surfactant, and/or chelate-free formulation.

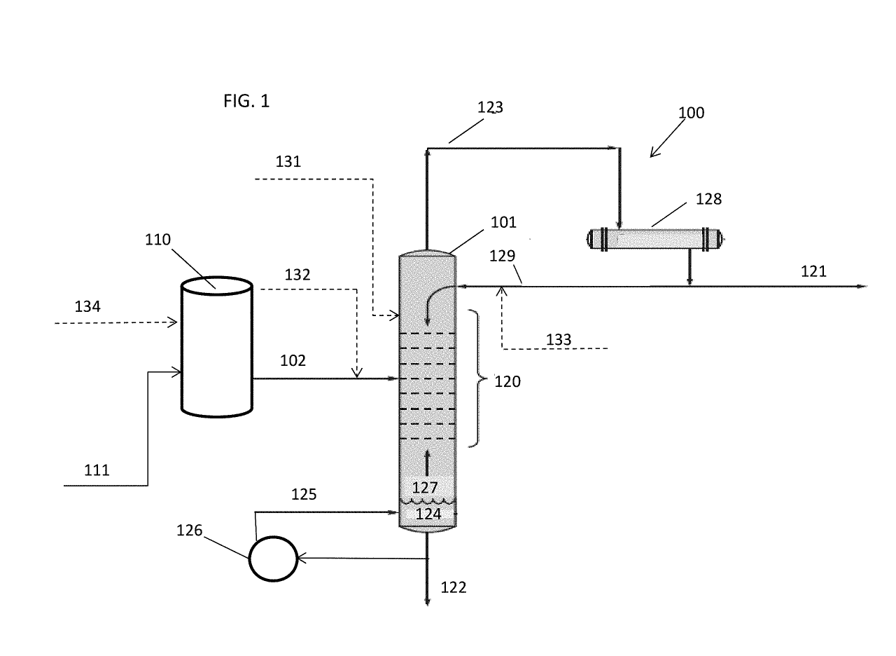

The use and performance of the chemical formulation of the present invention can be further appreciated with reference to an ethanol production plant. FIG. 1 shows a process flow 100 for ethanol recovery using a distillation column 101 in an ethanol production plant, which is shown in part in the drawing. The process flow shows a continuous-feed distillation column system, in which a feed 102 of fermented mash (“beer”) is pumped from a beer well 110 (or beer wells) into the distillation column 101. The fractionation process that occurs within the column 101 ultimately separates the feed stream 102 into two product fractions, which are an overhead condensed distillate product 121 and a stillage or bottoms product 122. The feed 102 is in flowable liquid form when introduced into the distillation column 101. The beer well 110 can be supplied with fermented mash 111 from one or more fermentation tanks (not shown). The fermented mash may be obtained from fermentation of a fermentable material in fermentation tank(s), which material may be grain (e.g., corn, wheat, grain sorghum, barley), cellulosic material (e.g., corn cobs, stalks, leaves), vegetables (e.g., potatoes), sugar crops (e.g., sugar cane), fruits (e.g., grapes, apples, plums), or other fermentable starch or carbohydrate sources, or any combinations thereof. As a specific option, the grain is corn and the fermented mash is corn mash. Additional information on fermentation and other process units that can be configured with a distillation column are shown in incorporated U.S. Pat. No. 8,951,960. The feed 102 can be heated to form a preheated liquid before introduction into the column 101. The distillation column 101 has a plurality of sieve trays 120 mounted horizontally at vertically spaced intervals within the height of the distillation column 101. The sieve trays increase the contact area between liquid and vapor phases within the column. Though eight trays are shown in FIG. 1 for illustration, the number of trays 120 can depend on the process design and specifications, and may be one or more, or two or more, or five or more, such as 5-20 trays, or more.

The part of the distillation column 101 above the feed point for feed 102 is referred to as the rectifying section, and below the feed point is referred to as the stripping section. On entering the column 101, the liquid feed 102 starts flowing downward but part of the feed, namely, the component(s) with lower boiling point(s), primarily ethanol, vaporizes and rises within the column. However, as the ethanol vapor rises, the ethanol cools, and while part of the ethanol continues up as vapor, some of the ethanol (enriched in the higher boiling point water component) begins to descend again. Vapor of increased alcohol concentration leaves the surface of each successive tray while traveling upward through the column. Ethanol-rich vapor 123 ultimately exits from the top of the column 101 and heavier liquid stillage products 122 exit from the bottom of the column 101. The bottom vessel part of the column 101 contains boiling liquid 124, which is heated with boil-up vapor 125 obtained from a portion of the bottoms products 122 that is recirculated through a reboiler 126. The bottom product 122 typically is a mixture of condensate water and some beer, in which not all alcohol was removed or distilled. Vapor 127 rises up into the column from the boiling liquid 124. The overhead vapor stream 123 can be cooled and condensed using a water-cooled or air-cooled condenser 128. The condensed overhead vapor is refluxed, wherein a portion 129 of the condensed overhead liquid product from the distillation tower is recirculated to the upper part of the column 101. This reflux flow produces a downward flowing liquid stream in the top (rectifying) section of the column above the introduction point of the fermented mash feed 102. The remaining non-returned highly-concentrated alcohol-water condensate or distillate is collected as overhead distillate product 121. For a typical feed 102 of fermented mash of 2 to 5 mole percent ethanol, an overhead distillate product of at least 180 proof (90% ethanol by volume), or at least 190 proof (95% ethanol by volume), or other concentrations may be obtained.

In continuous distillation, the system preferably is kept in a steady state or approximate steady state. Steady state means that quantities related to the process do not change as time passes during operation. Such constant quantities include, for example, pressures, feed input rate, output stream rates, heating and cooling rates, reflux ratio, and temperatures, and compositions at every point (location). As indicated, if fouling occurs during processing which plugs up holes in the sieve trays, back pressure can build on the distillation column, and steady state operation cannot be maintained, requiring process shutdown and cleaning. The chemical formulation of the present invention controls such fouling to permit continuous steady-state operation to be maintained for much longer periods of operation as compared to operation in the absence of the treatment.

The chemical formulation of the present invention can be introduced directly into the distillation column or indirectly into the distillation column via treatment of materials that are fed or recirculated into the column, where the formulation controls fouling on exposed surfaces within the column, such as the tray surfaces, internal column walls, or other parts therein. The chemical formulation, in a preferred option, is in the form of a concentrate formulation that contains all of the indicated components of the at least two non-ionic surfactants, the at least one anti-foam agent, the at least one alcohol, the at least one preservative, and water, in the same mixture, which can be used as a single treatment additive. As an option, the chemical formulation, such as in the form of a single treatment additive, can be introduced directly into the interior of the distillation column through one or more feed streams 131, such as via one or more access ports on the column vessel wall, or as pumped to a liquid distributor arranged inside the column (such as, e.g., near the top of the column at a location above all the trays), or other direct application methods. As other options, chemical formulation can be introduced into the fermented mash feed 102 with one or more feed streams 132, or with one or more feed streams 133 added to the recirculated condensed overhead stream 129, or with one or more feed streams 134 added to the fermented mash or “beer” in the beer well 110, or other direct or indirect introduction points, or any combination of these different introduction points. The reference to feed “streams” of the chemical formulation is for convenience, wherein the chemical formulation may be dosed continuously, intermittently (at regular or irregular intervals), or as a single dose. Intermittent dosing of the chemical formulation may be performed under process control on an as-needed basis, such as by monitoring the concentration of one or more ingredients thereof in the column or in a product or recirculation stream thereof, or by monitoring deposit control on column internal surfaces in real time (e.g., via sensors or a viewing port). As another option, the ingredients of the chemical formulation may be separately introduced, e.g., individually, or in lesser including groups of the components, into the distillation column or feed streams. If used, separate feed or injector means for ingredients of the chemical formulation may be clustered together or spaced apart.

The overall dose of the chemical formulation to a distillation column, such as an ethanol (beer) distillation column, can be from about 10 ppm to about 500 ppm, or from about 25 ppm to about 400 ppm, or from about 50 ppm to about 300 ppm, or from about 50 to about 100 ppm, or from about 75 ppm to about 250 ppm, or from about 100 ppm to about 300 ppm, or other dosages, based on the weight amount of fermented mash (w/w basis) present in the column. These dosages can apply to other treated process units, e.g., a beer well.

As an option, for an ethanol distillation column, all of the non-ionic surfactant, at least one anti-foam agent, at least one alcohol, at least one preservative, and water components of the chemical formulation of the present invention have higher boiling points compared to that of ethanol. In view of this, these components of the chemical formulation can be concentrated in the liquid phase in the column during the fractionation process. The same criterion can be used for the chemical formulation if used in other fractionation processes, such as distillation processes for recovery of other types of alcohols or compounds.

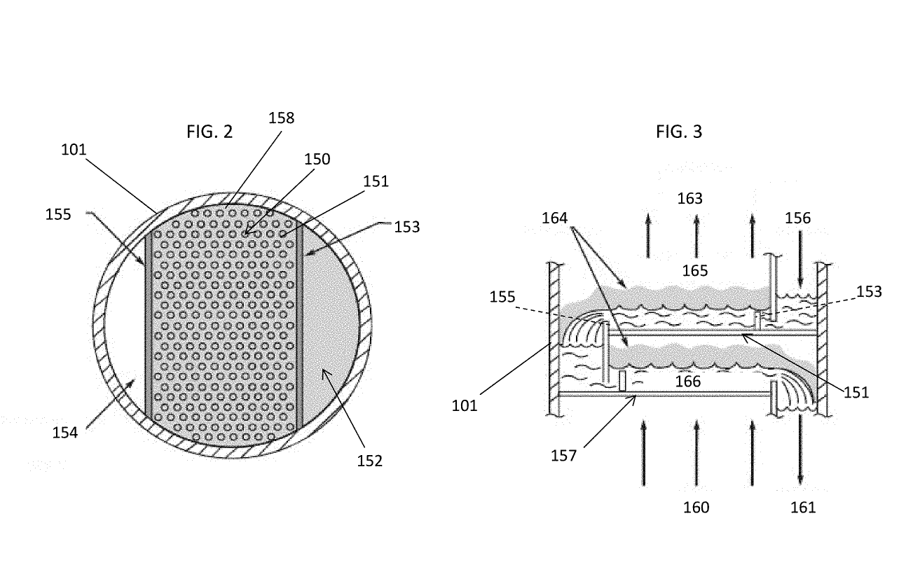

FIG. 2 shows a sieve tray 151, which can represent any one of the sieve trays 120 of the staged column shown in FIG. 1, mounted inside column 101. Sieve tray 151 has perforations or holes 150, e.g., punched circular holes, formed in a metal sheet 158 (e.g., a stainless steel sheet material). The entrance area 152 is for liquid containing chemical formulation of the present invention that is downcoming onto sieve tray 151 from a tray above (not shown). In use, a liquid layer is retained on the upper surface of the sieve tray 151, the depth of which is controlled by the height of the inlet weir 153 and outlet weir 155. The holes 150 in the tray 151 can be small enough that the vapor bubbles keep the liquid from passing through (e.g., 3/16 to about 1 inch in diameter, or other sizes). Downcomer area 154 allows flow of liquid from sieve tray 151 to the tray below (e.g., as shown in FIG. 3). As shown in FIG. 3, a downcoming liquid 156 which contains chemical formulation of the present invention flows across sieve tray 151 to form a liquid layer thereon, and then down to and across lower sieve tray 157 having a similar structure to tray 151 other than the opposite side locations for incoming and exiting liquids. Vapor 160 rising through the column 101 passes through holes in the trays 151 and 157 to provide vapor/liquid mixing 166 and vapor/liquid separation regions 165 on each tray. A froth zone 164 can form between these regions. Stripped liquid 161 flows out of each sieve tray downward in the column, and enriched vapor 163 proceeds up the column. Absent the presence of the chemical formulation, these trays inside column 101 can become plugged in the perforated areas with scale deposits. The presence of the chemical formulation can limit the frothing to give a better vapor/liquid separation. Based on the results of experimental studies that are disclosed herein, it is thought that the coordination and combination of all of the product ingredients in the chemical formulation is important to achieving this performance. Though not desiring to be bound to a theory, it is thought that electrostatic repulsion and steric hindrance inhibits aggregation and agglomeration of protein, inorganics and hydrocarbon thermosetting or thermoplastic hardening to polymers. The chemical formulation may also prevent crystals/particles from agglomerating and depositing on surface, disperse proteins and fine inorganic particles, reduce the required energy to disperse solids, lower viscosity of the solids dispersion, act as a deflocculation agent, interfere with protein and inorganic ion aggregation/deposition, or any combination thereof. Prevention of scale plugging using the chemical formulation of the present invention is a clearly different approach as opposed to stopping the production process in order to descale the trays.

As an option, the distillation tray may be a dual flow tray, which is a high hole area sieve tray without a downcomer (not shown). Further, though the chemical formulation of the present invention is illustrated for controlling fouling in a distillation column equipped with sieve trays, the chemical formulation can be used to control fouling in distillation columns which have other configurations for achieving counter-current vapor-liquid contact and mass transfer, such as valve trays, bubble cap trays, baffle trays, or packings (e.g., dumped packings such as Rashig Rings, Pall Rings, ceramic saddles, or structured packing). As another option, though illustrated for treatment of a distillation column operated in a “continuous mode,” the chemical formulation of the present invention may be used as an anti-fouling additive in a distillation column operated in “batch mode.”

Once a distillation column is brought into an operating balance in “continuous mode” with in-process real time treatment with the chemical formulation of the present invention, the operation can be sustained night and day, week after week, for extended time periods, without the need to shut down the process within relatively short recurrent time frames for cleaning maintenance and the associated appreciable losses in production.

Though illustrated herein for fouling control in an alcohol distillation column, the chemical formulation of the present invention can be used to control scale in other process units and equipment used in conjunction with an alcohol distillation column in the overall plant or in other chemical or biochemical process systems. In addition to deposit prevention in corn to ethanol distillation columns, the chemical formulation of the present invention can be used for deposit control in corn to ethanol evaporators, corn to ethanol heat exchange columns, in continuous process piping in corn to ethanol plants, in whole stillage tanks, beerwells, fermenters, propagator tanks, slurry tanks, and piping (e.g., for clean-in-place (CIP) piping), or other process units, handling structures, or parts.

The present invention will be further clarified by the following examples, which are intended to be exemplary of the present invention. In the following examples, and as an option in the chemical formulations of the present invention in general, water only assists solvation and is not a primary solvent. A non-ionic surfactant vesicular system where active vesicles reside in the product formula can be used as an option in the present invention.

### EXAMPLES

### Example 1

An experimental study was performed to test the efficacy of a chemical formulation of the present invention to prevent deposits from adhering to a test surface as compared to comparison formulations that contained a different ingredient or ingredients or no active ingredient (control).

A chemical formulation which represented the present invention in this example was identified as product “C”, and test slides treated with comparison products included product “A” (polyacrylic copolymer, 25 wt %, in aqueous solution), “B” (polymaleic polymer, 15 wt %, in aqueous solution), “D” (soy ester, 15 wt %, and dioctylsulfosuccinate (DOSS), 30 wt %, in aqueous solution), “E” (lecithin, 20 wt %, and phosphonate, 20 wt %, in aqueous solution), and a control (aqueous solution with no additive).

The chemical formulation which represented the present invention in this example had the following composition:

TABLE 1
Product “C” (present invention)

| | Concentration |
|---|---|
| Ingredient | (wt %) |
| Polysorbate (TWEEN 80) | 10 |
| Ethoxylated Castor Oil (40 moles | 5 |
| EO/mole castor oil) (40 moles | |
| ethoxylation) | |
| Polyglycol (EO-PO type) | 5 |
| Glycerol | 40 |
| Sodium benzoate | 0.1 |
| Potassium sorbate | 0.5 |
| Water | 39.4 |
| TOTAL | 100 |

A test assay was designed to replicate the conditions of a beer stripper column (185° F., 20-50% ethanol). Formulations were prepared to test for efficacy at preventing deposit adherence on a test surface of a test slide. The test slides which were used were thin flat-surfaced glass material, which had a 1 inch, by 3 inch (3 square inch surface face). A deposit sample obtained from a sieve tray of an ethanol distillation column was subjected to high speed blending and shearing of components in the presence of absolute ethanol and a test formulation, and then was made up in solution with 0.5% ionic salt and diluted adequately with 20% ethanol to maintain consistency of material in a distillation column, and heated to a temperature of 185° F., and then applied to a test surface of a test slide by painting the porous slide with an art brush and then fixed at a 45 degree angle for 30 minutes at 185 degree F. in an active rising vapor column. This experiment was to set up a precondition for the opportunity for scale to become fixed to the porous glass slide under the understanding that only test formulations that prevent scale particles from coalescing would prevent scale deposit adherence. After 30 minutes, the treated slides were visually examined with measurements made of the deposit area left on the surface to determine how much of the surface area of the slide was covered with the test solution as scale.

Table 2 shows the surface percentage of surface area of a test slide that is covered in scale/or deposit after treatment with an anti-fouling formulation according to an example of the present invention (“C”) and of test slides treated with comparison products (“A”, “B”, “D”, “E”) and a control (no additive).

TABLE 2

| Product Used For | Scale Build Up, |
|---|---|
| Treatment | Surface Area Coverage, % |
| Control | 100 |
| A | 74 |
| B | 85 |
| C (present invention) | 0 |
| D | 20 |
| E | 40 |

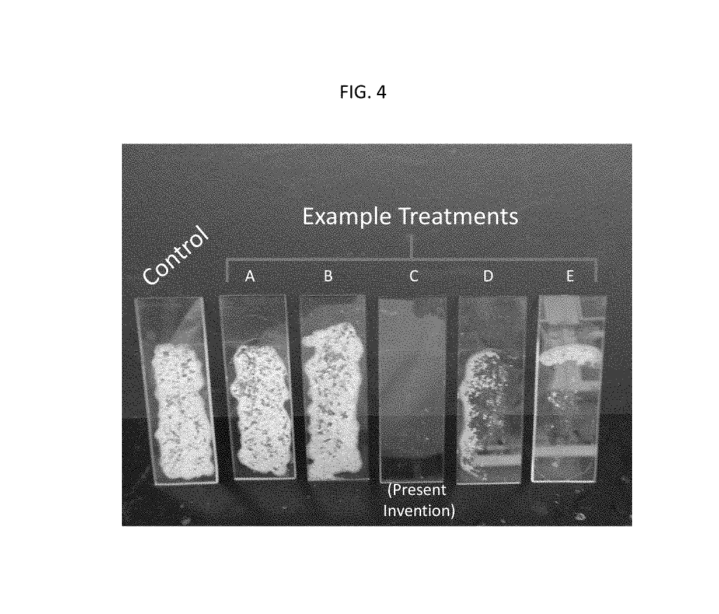

FIG. 4 is a photograph which shows the surface of a treated test slide after treatment with an anti-fouling composition according to an example of the present invention (“C”) and of the test slides treated with comparison products (“A”, “B”, “D”, “E”) and a control (no additive).

As shown in data in Table 1 and photographic results shown in FIG. 4, the test slide treated with the chemical formulation of the present invention (“C”) had no scale build up, whereas the test slides treated with comparison products (“A”, “B”, “D”, “E”) and a control (no additive) had significant scale build up.

### Example 2

Trials were conducted on a laboratory distillation column to study the level of scale control provided by a chemical formulation of the present invention as compared to treatments using as compared to comparison formulations that contained a different ingredient or ingredients or no active ingredient (control). The chemical formulation used to represent the present invention was the same as in Example 1. The additives used for this study and the % prevention of deposits in the distillation column, as determined by area calculation for the absence of scale deposits upon stainless steel slide trays, are shown in Table 3. The four inch diameter laboratory distillation column had 12 sieve trays. Corn mash was fed to the column at a feed rate of 3.0 liters/Hr, and at steady state operation, 10 wt % of bottom product was reboiled and recirculated to the bottom of the column, and the reflux rate for the overhead condensate was 1.1 liter/Hr. Multiple trial experiments were conducted per additive.

TABLE 3

| | Distillation column lab model with various | | | | |
|---|---|---|---|---|---|
| | treatments for % prevention of deposits | | | | |
| Additive | Trial 1 | Trial 2 | Trial 3 | Trial 4 | Trial 5 |
| Present Invention | 100 | 100 | 100 | 100 | 100 |
| Maleic polymer | 10 | 13 | 8 | 17 | 19 |
| Polyacrylic acid | 8 | 18 | 23 | 21 | 16 |
| EDTA* | 4 | 7 | 3 | 1 | 2 |
| HEDP** | 3 | 6 | 8 | 2 | 2 |
| Lecithin | 1 | 2 | 1 | 3 | 2 |
| Soy ester | 3 | 4 | 1 | 1 | 1 |
| Phosphonate | 3 | 2 | 9 | 4 | 1 |
| Sulfonate polyacrylic | 12 | 7 | 5 | 10 | 9 |
| Dioctyl sulfosuccinate | 13 | 18 | 24 | 19 | 27 |
| Polyacrylate homopolymer | 15 | 26 | 28 | 20 | 13 |

*ethylenediaminetetraacetic acid
**hydroxyethylidene diphosphonic acid

As shown by the results in Table 3, only the present invention completely inhibited scale build up. The comparison products were much lower (inferior) in scale prevention as compared to complete prevention provided by the chemical formulation of the present invention.

### Example 3

Additional trials were conducted on the laboratory distillation column used in Example 2 to evaluate the necessity of combining all the components of the chemical formulation of the present invention to achieve the preventative effect on deposition. A chemical formulation of the present invention, such as disclosed in Example 1, was compared to treatments using only one or a subgroup of the ingredients of the chemical formulation of the present invention. The additives used for this study and the % prevention of deposits in the distillation column, are shown in Table 4. Multiple trial experiments were conducted per additive.

TABLE 4

| | Distillation column lab model with various | | |
|---|---|---|---|
| | treatments for % prevention of deposits | | |
| Additive | Trial 1 | Trial 2 | Trial 3 |
| Present Invention (Complete | 100% | 100% | 100% |
| formula) | | | |
| Polysorbate | 54% | 61% | 57% |
| castor oil ethoxylated | 41% | 33% | 42% |
| polyglycol antifoam | 39% | 27% | 33% |
| Glycerol | 11% | 16% | 12% |
| Water | 1% | 1% | 1% |
| benzoates/sorbates | 1% | 0% | 1% |
| polysorbate/castor oil | 67% | 71% | 73% |
| ethoxylated | | | |
| polysorbate/castor oil | 89% | 92% | 87% |
| ethoxylated /antifoam | | | |
| polysorbate/castor oil | 98% | 100% | 100% |
| ethoxylated/antifoam/glycerol | | | |

As shown by the results in Table 4, it is necessary to combine all the active ingredients specified for the chemical formulation of the present invention, i.e., the at least two non-ionic surfactants, the at least one anti-foam agent, the least one alcohol, and the least one preservative, to achieve 100% preventative effect of deposition in every trial. The lesser included combination of the at least two non-ionic surfactants, the at least one anti-foam agent, and the least one alcohol, without the preservative, provided 100% prevention in some but not all of the trials. The other lesser included combinations of components were much lower (inferior) in scale prevention as compared to complete prevention provided by the complete formula.

The present invention includes the following aspects/embodiments/features in any order and/or in any combination:

1. The present invention relates to a chemical formulation comprising
a. at least two non-ionic surfactants;
b. at least one anti-foam agent;
c. at least one alcohol;
d. optionally at least one preservative; and
e. water,
   wherein a. through d. are different from each other, and wherein the chemical formulation is animal food grade.
   2. The chemical formulation of any preceding or following embodiment/feature/aspect, wherein the at least two non-ionic surfactants are at least one polysorbate and at least one alkoxylated castor oil.
   3. The chemical formulation of any preceding or following embodiment/feature/aspect, wherein the at least two non-ionic surfactants are at least one polysorbate and at least one ethoxylated castor oil.
   4. The chemical formulation of any preceding or following embodiment/feature/aspect, wherein the ethoxylated castor oil has from about 30 moles of ethylene oxide to 80 moles of ethylene oxide per mole of castor oil.
   5. The chemical formulation of any preceding or following embodiment/feature/aspect, wherein the ethoxylated castor oil has from about 40 moles of ethylene oxide to 60 moles of ethylene oxide per mole of castor oil.
   6. The chemical formulation of any preceding or following embodiment/feature/aspect, wherein the at least one anti-foam agent is at least one polyglycol.
   7. The chemical formulation of any preceding or following embodiment/feature/aspect, wherein the at least one preservative is present and comprises benzoate, a sorbate, or both.
   8. The chemical formulation of any preceding or following embodiment/feature/aspect, wherein the at least one preservative is present and comprises benzoate, a potassium sorbate, or both.
   9. The chemical formulation of any preceding or following embodiment/feature/aspect, wherein the at least one alcohol is at least one polyhydric alcohol.
   10. The chemical formulation of any preceding or following embodiment/feature/aspect, wherein the at least one alcohol is at least one glycerol.
   11. The chemical formulation of any preceding or following embodiment/feature/aspect, wherein the a. through e. are present in the following amounts:
a. from about 10 wt % to about 20 wt % of the at least two non-ionic surfactants;
b. from about 1 wt % to about 10 wt % of the at least one anti-foam agent;
c. from about 25 wt % to about 50 wt % of the at least one alcohol;
d. from about 0.25 wt % to about 5 wt % of the at least one preservative;
e. from about 1 wt % to about 40 wt % of the water, all based on total weight of the chemical formulation.
   12. The chemical formulation of any preceding or following embodiment/feature/aspect, the chemical formulation comprising:
at least one polysorbate;
at least one ethoxylated castor oil;
at least one polyglycol;
at least one glycerol;
at least one preservative; and
water.
   13. The chemical formulation of any preceding or following embodiment/feature/aspect, the chemical formulation comprising:
at least one polysorbate;
at least one ethoxylated castor oil;
at least one polyglycol;
at least one glycerol;
benzoate and potassium sorbate; and
water.
   14. The chemical formulation of any preceding or following embodiment/feature/aspect, the chemical formulation comprising:
from about 5 wt % to about 15 wt % of at least one polysorbate;
from about 2 wt % to about 10 wt % of at least one ethoxylated castor oil;
from about 2 wt % to about 10 wt % of at least one polyglycol;
from about 30 wt % to about 50 wt % of at least one glycerol;
from about 0.25 wt % to about 3 wt % of at least one preservative; and
from about 10 wt % to about 40 wt % water, based on total weight of the chemical formulation.
   15. The chemical formulation of any preceding or following embodiment/feature/aspect, wherein the chemical formulation is a silane-free, silicon-free, and silicone-free formulation.
   16. The chemical formulation of any preceding or following embodiment/feature/aspect, wherein the chemical formulation is an acid-free, base-free, cationic-free surfactant, anionic-free surfactant, and/or chelate-free formulation.
   17. The present invention relates to a method to control fouling in a distillation column comprising conducting distillation in the distillation column in the presence of the chemical formulation of any one of any preceding or following embodiment/feature/aspect.
   18. The method of any preceding or following embodiment/feature/aspect, wherein the distillation is alcohol distillation.
   19. The method of any preceding or following embodiment/feature/aspect, wherein the distillation is ethanol distillation.
   20. The method of any preceding or following embodiment/feature/aspect, wherein the distillation is ethanol distillation from fruits, vegetables, cellulosic material, or any combinations thereof.
   21. The method of any preceding or following embodiment/feature/aspect, wherein the distillation is ethanol distillation from corn or corn mash.
   22. The method of any preceding or following embodiment/feature/aspect, the method further comprising a) combining the chemical formulation with mash prior introducing the mash into the distillation column, or b) introducing the chemical formulation and the mash separately into the distillation column.
   23. The method of any preceding or following embodiment/feature/aspect, wherein the chemical formulation is introduced continuously into the distillation column during the distillation.
   24. The method of any preceding or following embodiment/feature/aspect, wherein the chemical formulation is present in an amount of from about 10 ppm to 500 ppm based on the amount of mash present.
   25. The method of any preceding or following embodiment/feature/aspect, wherein the fouling is prevented by the method.
   26. The method of any preceding or following embodiment/feature/aspect, wherein distillation column comprises at least one wall and trays, and the fouling is controlled on the at least one wall and the trays.
   27. The method of any preceding or following embodiment/feature/aspect, wherein the fouling comprises organic thermoplastic deposition, inorganic depositions, or both.
   28. The method of any preceding or following embodiment/feature/aspect, wherein the fouling comprises fouling from proteins, sugar, minerals or any combination thereof.
   29. The method of any preceding or following embodiment/feature/aspect, wherein the method is a clean-in-place (CIP) method.
   30. The method of any preceding or following embodiment/feature/aspect, wherein the method occurs in the absence of shutting down the distillation column or stopping the distillation.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A chemical formulation comprising
a. at least two non-ionic surfactants;
b. at least one anti-foam agent;
c. at least one alcohol;
d. optionally at least one preservative; and
e. water,
wherein a. through d. are different from each other, and wherein said chemical formulation is animal food grade.

2. The chemical formulation of claim 1, wherein the at least two non-ionic surfactants are at least one polysorbate and at least one alkoxylated castor oil.

3. The chemical formulation of claim 1, wherein the at least two non-ionic surfactants are at least one polysorbate and at least one ethoxylated castor oil.

4. The chemical formulation of claim 3, wherein the ethoxylated castor oil has from about 30 moles of ethylene oxide to 80 moles of ethylene oxide per mole of castor oil.

5. The chemical formulation of claim 3, wherein the ethoxylated castor oil has from about 40 moles of ethylene oxide to 60 moles of ethylene oxide per mole of castor oil.

6. The chemical formulation of claim 1, wherein said at least one anti-foam agent is at least one polyglycol.

7. The chemical formulation of claim 1, wherein said at least one preservative is present and comprises benzoate, a sorbate, or both.

8. The chemical formulation of claim 1, wherein said at least one preservative is present and comprises benzoate, a potassium sorbate, or both.

9. The chemical formulation of claim 1, wherein said at least one alcohol is at least one polyhydric alcohol.

10. The chemical formulation of claim 1, wherein said at least one alcohol is at least one glycerol.

11. The chemical formulation of claim 1, wherein said a. through e. are present in the following amounts:
a. from about 10 wt % to about 20 wt % of the at least two non-ionic surfactants;
b. from about 1 wt % to about 10 wt % of the at least one anti-foam agent;
c. from about 25 wt % to about 50 wt % of the at least one alcohol;
d. from about 0.25 wt % to about 5 wt % of the at least one preservative;
e. from about 1 wt % to about 40 wt % of the water, all based on total weight of said chemical formulation.

12. The chemical formulation of claim 1, said chemical formulation comprising:
at least one polysorbate;
at least one ethoxylated castor oil;
at least one polyglycol;
at least one glycerol;
at least one preservative; and
water.

13. The chemical formulation of claim 1, said chemical formulation comprising:
at least one polysorbate;
at least one ethoxylated castor oil;
at least one polyglycol;
at least one glycerol;
benzoate and potassium sorbate; and
water.

14. The chemical formulation of claim 1, said chemical formulation comprising:
from about 5 wt % to about 15 wt % of at least one polysorbate;
from about 2 wt % to about 10 wt % of at least one ethoxylated castor oil;
from about 2 wt % to about 10 wt % of at least one polyglycol;
from about 30 wt % to about 50 wt % of at least one glycerol;
from about 0.25 wt % to about 3 wt % of at least one preservative; and
from about 10 wt % to about 40 wt % water, based on total weight of said chemical formulation.

15. The chemical formulation of claim 1, wherein said chemical formulation is a silane-free, silicon-free, and silicone-free formulation.

16. The chemical formulation of claim 1, wherein said chemical formulation is an acid-free, base-free, cationic-free surfactant, anionic-free surfactant, and/or chelate-free formulation.

17. A method to control fouling in a distillation column comprising conducting distillation in said distillation column in the presence of the chemical formulation of claim 1.

18. The method of claim 17, wherein said distillation is alcohol distillation.

19. The method of claim 17, wherein said distillation is ethanol distillation.

20. The method of claim 17, wherein said distillation is ethanol distillation from fruits, vegetables, cellulosic material, or any combinations thereof.

21. The method of claim 17, wherein said distillation is ethanol distillation from corn or corn mash.

22. The method of claim 17, said method further comprising a) combining said chemical formulation with mash prior introducing said mash into said distillation column, or b) introducing said chemical formulation and said mash separately into said distillation column.

23. The method of claim 17, wherein said chemical formulation is introduced continuously into said distillation column during said distillation.

24. The method of claim 17, wherein the chemical formulation is present in an amount of from about 10 ppm to 500 ppm based on said amount of mash present.

25. The method of claim 17, wherein said fouling is prevented by said method.

26. The method of claim 17, wherein distillation column comprises at least one wall and trays, and said fouling is controlled on said at least one wall and said trays.

27. The method of claim 17, wherein said fouling comprises organic thermoplastic deposition, inorganic depositions, or both.

28. The method of claim 17, wherein said fouling comprises fouling from proteins, sugar, minerals or any combination thereof.

29. The method of claim 17, wherein said method is a clean-in-place (CIP) method.

30. The method of claim 17, wherein said method occurs in the absence of shutting down the distillation column or stopping said distillation.
